(19) United States
(12) Patent Application Publication
(10) Pub. No.: US 2009/0229404 A1
(43) Pub. Date: Sep. 17, 2009

(54) Bicycle stem and bicycle stem system with interlocking components

(76) Inventor: Ronald Scott Wilkerson, Santa Cruz, CA (US)

Correspondence Address: MICHAEL A. GUTH, 2-2905 EAST CLIFF DRIVE, SANTA CRUZ, CA, 95062, US

(21) Appl. No.: 12/322,343

(22) Filed: Jan. 30, 2009

Related U.S. Application Data
(60) Provisional application No. 61/025,159, filed on Jan. 31, 2008.
(60) Provisional application No. 61/025,100, filed on Jan. 31, 2008.

(51) Int. Cl. B62K 21/16

(52) U.S. Cl. 74/551.3

(57) ABSTRACT

A bicycle stem and bicycle component system adapted to more firmly grip the handlebars to which the stem is attached. The bicycle stem may have locking features, such as splines, adapted to mate into a matching interface on the handlebars. A bicycle stem and bicycle component system adapted to lock the stem into a fixed relationship with the forks of the bicycle. The bicycle stem may have locking features, such as splines, adapted to mate into a matching interface on the forks.

### CROSS REFERENCE TO RELATED APPLICATIONS

This application claims priority to U.S. Provisional Application No. 61/025,159 to Wilkerson, filed Jan. 31, 2008, and also claims priority to U.S. Provisional Application No. 61/025,100 to Wilkerson, filed Jan. 31, 2008, both of which are hereby incorporated by reference in their entirety.

### BACKGROUND

1. Field of the Invention

This invention relates to bicycles, and more specifically to a bicycle stem and a bicycle stem system with interlocking components.

2. Description of Related Art

Bicycles are widely used for transportation and recreation. A typical bicycle includes a rear wheel carried by a frame and affront wheel carried by a fork that is rotatably connected to a forward portion of the frame. A steering tube is connected at its lower end to the fork and extends through a corresponding passageway in the forward portion of the frame. An upper portion of the steering tube is connected to a bicycle stem.

The bicycle stem attaches to the upper end of the steering tube at a first end, and attaches to the handlebar at a second end. Typically, the middle of the handlebar is attached to the stem with a clamping portion. The rider is thus able to steer the front wheel by turning the handlebar, and also obtain leverage over the bicycle by pushing or pulling on the handlebar.

The stem is important for proper orientation of the rider relative to the bicycle. Although true to some extent in all types of riding, certain types of high performance riding demand more out of the stem and the fork/stem/handlebar system. For example, BMX riding wherein the rider may perform jumping maneuvers wherein the bicycle and its handlebars receive much higher loads.

What is called for is a high strength bicycle stem which is able to maintain alignment of the stem with the steering tube under high loads, and which allows for positional selection of the angle between the handlebar and the stem, while also being able to maintain alignment of the stem with the handlebar under high loads.

### SUMMARY

A bicycle stem and bicycle component system adapted to more firmly grip the handlebars to which the stem is attached. The bicycle stem may have locking features, such as splines, adapted to mate into a matching interface on the handlebars. A bicycle stem and bicycle component system adapted to lock the stem into a fixed relationship with the forks of the bicycle. The bicycle stem may have locking features, such as splines, adapted to mate into a matching interface on the forks.

### BRIEF DESCRIPTION OF THE DRAWINGS

FIG. 1 is a bottom view of a handlebar.

FIG. 2 is a front view of a handlebar.

FIG. 3 is a front view of a fork and steering tube assembly.

FIG. 4 is a side view of a fork and steering tube assembly.

FIG. 5 is a side view of a bicycle frame.

FIG. 6 is a sketch of a bicycle.

FIG. 7 is a front view of the first end of a bicycle stem according to some embodiments of the present invention.

FIG. 8 is side view of the first end of a bicycle stem according to some embodiments of the present invention.

FIG. 9 is a view of a detail of a portion of a bicycle stem according to some embodiments of the present invention.

FIG. 10 is a perspective view of a bicycle stem according to some embodiments of the present invention.

FIG. 11 is a front view of a handlebar clamping portion of a bicycle stem according to some embodiments of the present invention.

FIG. 12 is a side view of a handlebar clamping portion of a bicycle stem according to some embodiments of the present invention.

FIG. 13 is a view of a detail of a portion of a handlebar clamping portion of a bicycle stem according to some embodiments of the present invention.

FIG. 14 is a perspective view of a handlebar clamping portion of a bicycle stem according to some embodiments of the present invention.

FIG. 15 is a front view of a handlebar according to some embodiments of the present invention.

FIG. 16 is a bottom view of a handlebar according to some embodiments of the present invention.

FIG. 17 is a detail of a handlebar according to some embodiments of the present invention.

FIG. 18 is a top view of a bicycle stem according to some embodiments of the present invention.

FIG. 19 is a perspective view of a bicycle stem according to some embodiments of the present invention.

FIG. 20 is a front view of a fork and steering tube assembly according to some embodiments of the present invention.

FIG. 21 is a cross-sectional view of a steering tube according to some embodiments of the present invention.

### DETAILED DESCRIPTION

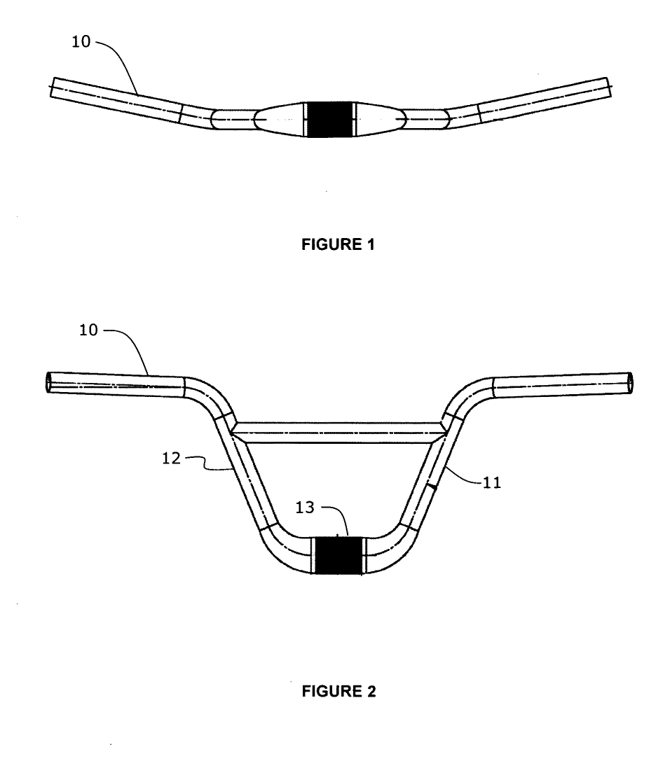

FIGS. 1 and 2 illustrate a typical handlebar 10 with a first side 11 and a second side 12 splaying out to the side to present handgrip areas for the rider. The center middle section is an interface portion 13 adapted to reside within the bicycle stem, which in turn links the handlebar 10 to the steering tube of the fork assembly.

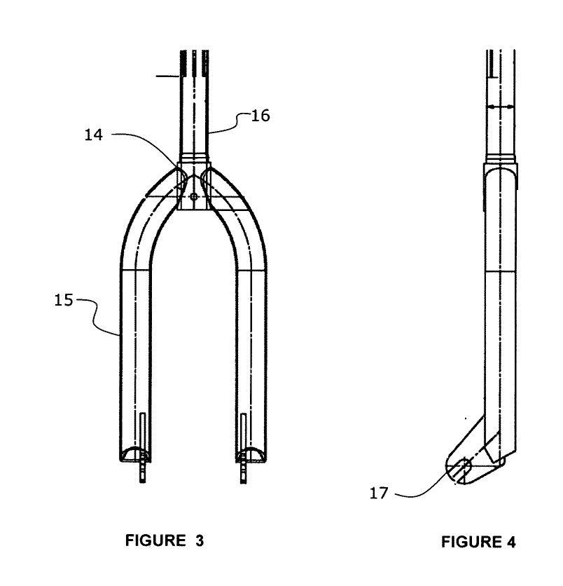

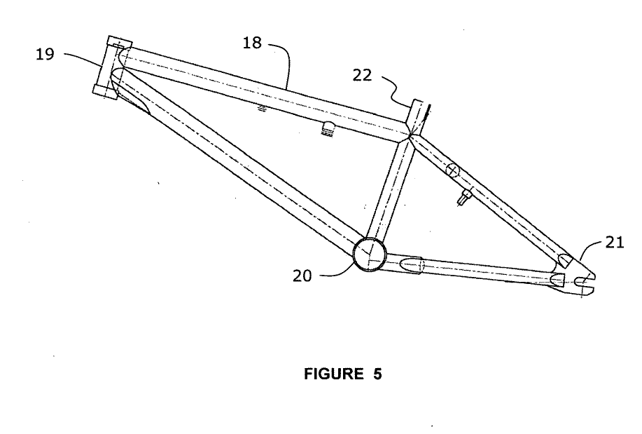

FIGS. 3 and 4 illustrate a fork assembly 14 which is used to attach the front tire to the bicycle frame while allowing for rotation of the steering tube 16 around its long axis to allow for the turning of the front wheel. The fork 15 is attached to the steering tube 16. The front tire may be attached at attach points 17. FIG. 5 illustrates bike frame 18 which is adapted to serve as the basis of a bicycle. A front tube 19 is adapted to receive the steering tube of the fork assembly, and typically includes a bearing set within it to rotatably support the steering tube. The crank interface 20 is adapted to support the crank and pedals, which are typically supported by a bearing set. The seat tube interface 22 is adapted to receive a seat post for a seat. The rear bracket 21 is adapted to receive the rear wheel.

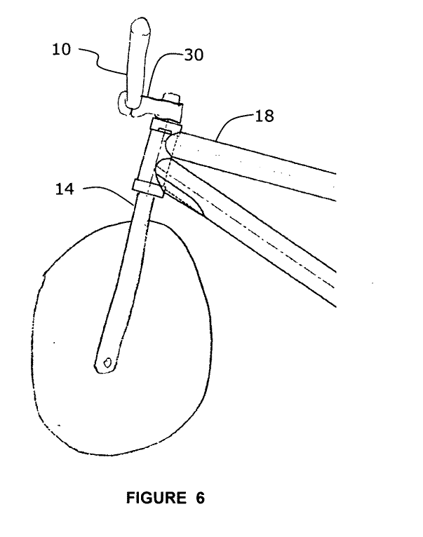

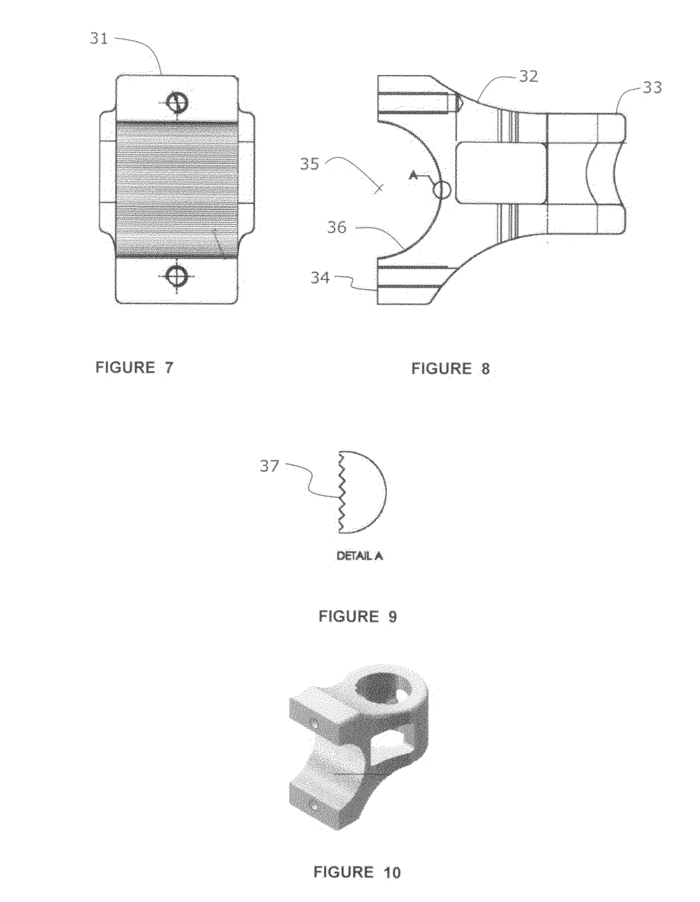

FIG. 6 illustrates a bicycle with a frame 18 and a fork assembly 14 inserted through the front tube 19 of the frame 18. A stem 30 is attached to the steering tube on a first end and to a handlebar 10 on a second end. In some embodiments of the present invention, as seen in FIGS. 7-10, a bicycle stem 31 is seen with a body 32 having a first end 33 and a second end 34. The first end 33 is adapted to interface with a steering tube, and the second end 34 is adapted to interface with a handlebar. The second end 34 is seen with a handlebar clamping portion 36, which is a partial interior cylinder defining a passageway 35 adapted for receiving the interface portion of a handlebar in some embodiments. In some embodiments, the handlebar clamping portion has mechanical features adapted to lock to the mated handlebar. In some embodiments, the mechanical features are a series of angular grooves 37.

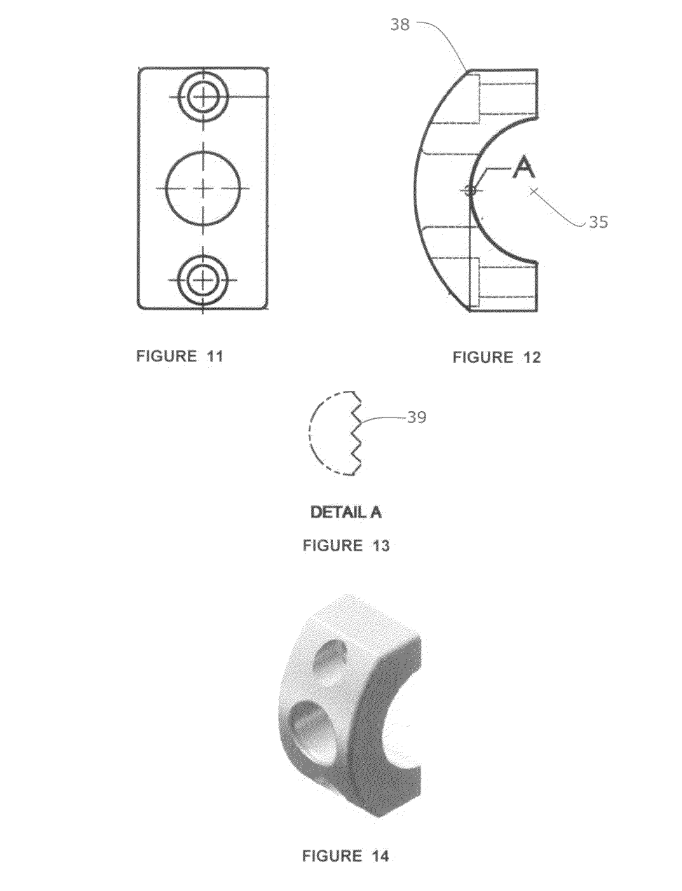

In some embodiments of the present invention, as seen in FIGS. 11-14, a handlebar clamping member 38 is seen. The handlebar clamping member 38 is adapted to be fastened to the body 32 of the stem 31 with threaded fasteners. The member 38 has an interior surface which defines another portion of the passageway 35 adapted for receiving the interface portion of a handlebar in some embodiments. In some embodiments, the handlebar clamping member has mechanical features adapted to lock to the mated handlebar. In some embodiments, the mechanical features are a series of angular grooves 39.

With the mechanical features facing the handlebar passageway, the handlebars may be locked into a position when the handlebars are contained therein in a much more secure fashion. With the plurality of mating grooves, a multitude of positions may be selected by the user, and the handlebars may be “locked” into the selected position.

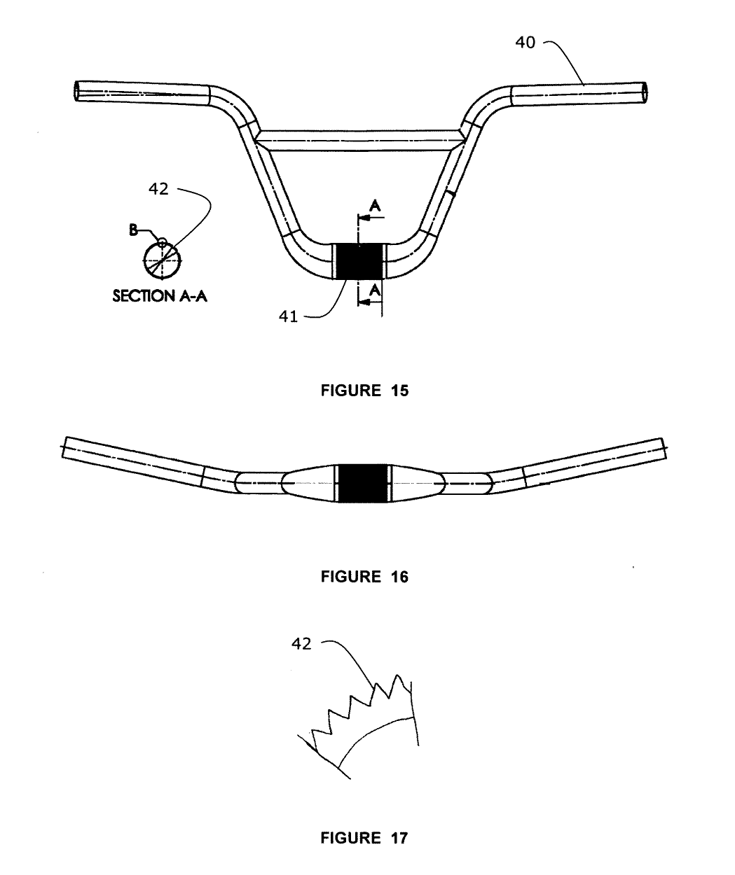

In some embodiments of the present invention, as seen in FIGS. 15-17, a handlebar 40 is seen and is adapted to be used as part of a system with a stem as described above. The handlebar 40 has an interface portion 41 with mechanical features adapted to interlock with mating features on the interior passageway of the stem. In some embodiments, the mechanical features of the handlebar interface portion 41 are a series of grooves 42.

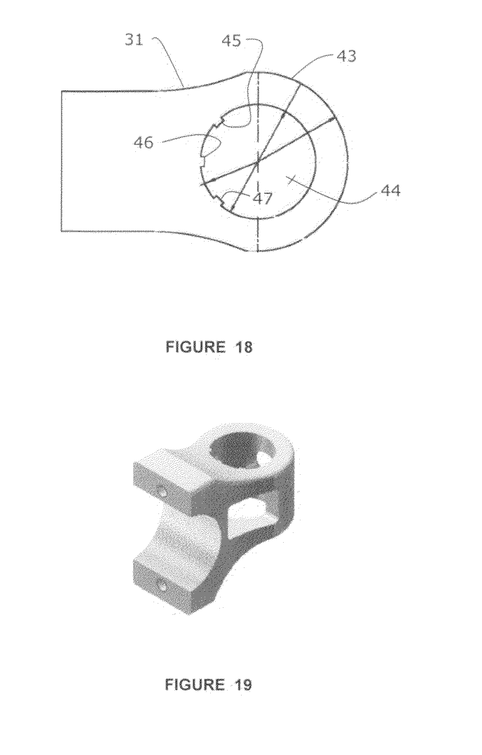

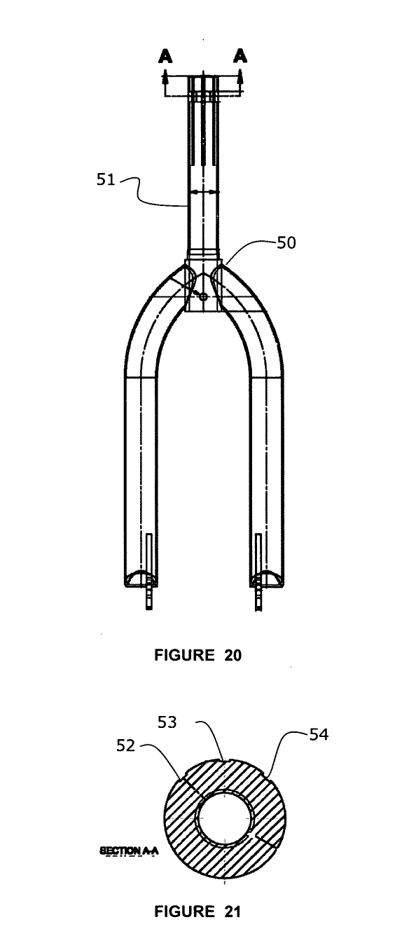

In some embodiments of the present invention, as seen in FIGS. 18-19, the stem 31 is seen with a passageway 44 adapted for mating to the steering tube of a fork assembly at the first end 33 of the body 32. In some embodiments, the passageway 44 may be substantially cylindrical along its interior and may include integral keys 45, 46, 47 adapted to prevent rotation of the stem 31 relative to the steering tube along the main axis of the steering tube.

In some embodiments of the present invention, as fork assembly 50 is seen with a steering tube 51 thereon. The steering tube is adapted to mate with a stem as described above. The steering tube 51 may include grooves 52, 53, 54 adapted to mate with the keys of the stem. When connecting the steering tube to the stem, a pair of clamps with a threaded fastener may be inserted into the side holes of the stem in the area of the steering tube interface.

In some embodiments, the stem 31 is made from 6061 Al alloy. In some embodiments, the stem is machined from a single piece. Among the advantages of the stem, and the stem with handlebars system, and stem with forks system, and the stem with forks and handlebars system, are the compact and strong nature of the system. In addition to the locking aspect of the handlebar positions, there are a number of handlebar positions that can be locked in available to the user. In addition, as a complete system, the size and weight of the system is low, and is coupled with significant enhancement of the positional holding of the system components relative to one another.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

I claim:

1. A bicycle stem system, said system comprising:
a bicycle stem, said bicycle stem comprising:
a body having a first end and a second end;
a steering tube interface portion at said first end of said body;
a handlebar clamping portion at said second end of said body defining a first part of a handlebar receiving passageway;
a handlebar clamping member defining a second part of a handlebar receiving passageway, said handlebar clamping member adapted to be removably fastened to said handlebar clamping portion,
wherein said handlebar receiving passageway defines a first axis for insertion of a tubular portion of a handlebar, and wherein said handlebar clamping portion comprises a first plurality of mechanical features adapted to restrict rotation of a handlebar placed in said handlebar receiving passageway relative to said first axis, and wherein said handlebar clamping member comprises a second plurality of mechanical features adapted to restrict rotation of a handlebar placed in said handlebar receiving passageway relative to said first axis.

2. The bicycle stem system of claim I wherein said first and said second plurality of mechanical features adapted to restrict rotation of a handlebar comprise a plurality of grooves.

3. The bicycle stem system of claim I further comprising a handlebar, said handlebar comprising and interface tube portion adapted to be clamped in said handlebar receiving passageway, wherein said interface tube portion comprises a third plurality of mechanical features adapted to mate with said first and said second of plurality of features to restrict rotation of said handlebar.

4. The bicycle stem system of claim 2 further comprising a handlebar, said handlebar comprising and interface tube portion adapted to be clamped in said handlebar receiving passageway, wherein said interface tube portion comprises a third plurality of mechanical features adapted to mate with said first and said second of plurality of features to restrict rotation of said handlebar, wherein said third plurality of mechanical features comprise a plurality of grooves.

5. The bicycle stem system of claim I wherein said steering tube interface portion comprises a cylindrical passageway, said cylindrical passageway adapted to fit over the steering tube of a bicycle fork, said cylindrical passageway comprising one or more integral keys protruding into said cylindrical passageway.

6. The bicycle stem system of claim 2 wherein said steering tube portion comprises a cylindrical passageway, said cylindrical passageway adapted to fit over the steering tube of a bicycle fork, said cylindrical passageway comprising one or more integral keys protruding into said cylindrical passageway.

7. The bicycle stem system of claim 5 further comprising a bicycle fork assembly, said fork assembly comprising a steering tube, wherein said steering tube comprises a cylindrical portion adapted to mate with said cylindrical passageway.

8. The bicycle stem system of claim 7 wherein said cylindrical portion comprises one or more slots along its outer surface adapted to mate with said one or more integral keys, wherein said slots parallel to the main axis of said cylindrical portion.

9. A bicycle stem system, said system comprising:
a bicycle stem, said bicycle stem comprising:
a body having a first end and a second end;
a steering tube interface portion at said first end of said body;
a handlebar clamping portion at said second end of said body defining a first part of a handlebar receiving passageway;
wherein said steering tube interface portion comprises a cylindrical passageway, said cylindrical passageway adapted to fit over the steering tube of a bicycle fork, said cylindrical passageway comprising one or more integral keys protruding into said cylindrical passageway.

10. The bicycle stem system of claim 9 further comprising a bicycle fork assembly, said fork assembly comprising a steering tube, wherein said steering tube comprises a cylindrical portion adapted to mate with said cylindrical passageway.

11. The bicycle stem system of claim 10 wherein said cylindrical portion comprises one or more slots along its outer surface adapted to mate with said one or more integral keys, wherein said slots parallel to the main axis of said cylindrical portion.

12. The bicycle stem system of claim 4 wherein said steering tube interface portion comprises a cylindrical passageway, said cylindrical passageway adapted to fit over the steering tube of a bicycle fork, said cylindrical passageway comprising one or more integral keys protruding into said cylindrical passageway.

13. The bicycle stem system of claim 12 further comprising a bicycle fork assembly, said fork assembly comprising a steering tube, wherein said steering tube comprises a cylindrical portion adapted to mate with said cylindrical passageway.

14. The bicycle stem system of claim 13 wherein said cylindrical portion comprises one or more slots along its outer surface adapted to mate with said one or more integral keys, wherein said slots parallel to the main axis of said cylindrical portion.
